(19) United States
(12) Patent Application Publication
(10) Pub. No.: US 2025/0385786 A1
(43) Pub. Date: Dec. 18, 2025

(54) Digital Vehicle Key for a Motor Vehicle

(71) Applicant: Bayerische Motoren Werke Aktiengesellschaft, Muenchen (DE)

(72) Inventors: Marco HIPPLER, Muenchen (DE); Thorsten KNOTT, Tuntenhausen (DE); Daniel KUELZER, Muenchen (DE)

(21) Appl. No.: 19/211,437

(22) Filed: May 19, 2025

(30) Foreign Application Priority Data
Jun. 17, 2024 (DE) 10 2024 117 006.9

(51) Int. Cl. H04L 9/08; B60R 25/01; G07C 9/00

(52) U.S. Cl. CPC H04L 9/0861; G07C 9/00309; B60R 25/01; G07C 2009/00531

(57) ABSTRACT

A method for controlling a motor vehicle includes authenticating a user of a mobile device, including determining a user account of the user, determining that the user account corresponds to a user account which has been associated with an existing owner key for the motor vehicle and storing an additional digital owner key for the motor vehicle for the user.

### CROSS REFERENCE TO RELATED APPLICATION

This application claims priority under 35 U.S.C. § 119 from German Patent Application No. 10 2024 117 006.9, filed Jun. 17, 2024, the entire disclosure of which is herein expressly incorporated by reference.

### BACKGROUND AND SUMMARY

The present invention relates to a digital vehicle key for a motor vehicle. In particular, the invention relates to creating an owner key.

A motor vehicle will be set up to be controlled by means of a digital vehicle key. A digital owner key must initially be created for this function, one which can be assigned to a legal owner of the vehicle. The person to whom the owner key is to be assigned is to be authenticated during this process. To achieve this, the person can, for example, present two physical vehicle keys for the vehicle or contact an office which verifies their identity or legal status, for example, on the basis of an ID document.

A locksmith can sign a request to create the owner key, store information relating to the owner key locally and provide an attestation package to the vehicle. The attestation package can include a public key for the person, which the vehicle can thereby store. The person can use a corresponding private key to execute an asymmetric cryptographic procedure with the motor vehicle to control a security function of the motor vehicle. In particular, the security function can include unlocking a door, tailgate or boot as well as deactivating an immobilizer.

An owner key can be utilized to create a user key for another person. If it is possible to define several owner keys, then exchanging a mobile device on which an owner key is stored can lead to situations which are difficult for a user to understand.

An underlying task of the present invention is to provide an improved technology for managing digital vehicle keys for a motor vehicle. The invention solves this task by means of the objects stated in the independent claims. Subclaims indicate preferred embodiments.

According to a first aspect of the present invention, a method for controlling a motor vehicle comprises the steps of authenticating a user of a mobile device, whereby the authentication comprises determining a user account of the user, determining that the user account corresponds to a user account associated with an existing owner key for the motor vehicle, and storing an additional digital owner key of the motor vehicle for the user.

This enables the user to equip a new mobile device with a new owner key and utilize it to control the vehicle. In practice, any number of mobile devices can be assigned to the user, each of which can have its own, assigned digital owner key stored on it.

If it is determined that the user account of the created owner key is different from all user accounts which have been assigned to one of the existing owner keys, then an existing owner key can be subsequently deleted. In this case, an amendment for the owner can be assumed in which the authorizations of a previous owner should not be maintained.

Preferably, all existing owner keys will be deleted in this case. A digital vehicle key, which has been validated with the existing owner key, can also be deleted. In particular, all vehicle keys which have been validated with an existing owner key can be deleted. In a simplified version, all vehicle keys can be deleted in a one-off process before the new owner key is installed.

The user can be logged into the user account on the mobile device. The user account can therefore be managed by an operating system located on the mobile device. The mobile device is preferably a personal device which has been assigned to the user. In particular, the mobile device can comprise a smartphone, a smart watch, a smart armband, a body-worn device (wearable) or a head-mounted device (attached on the). For example, the operating system can be iOS, where the user account can comprise an AppleID, or Android whereby the user account can comprise a Google account. A digital vehicle key technology described herein is compatible with the aforementioned operating systems and user accounts, other systems can also be supported.

The digital vehicle key is still to be preferably implemented in accordance with the specifications of the Car Connectivity Consortium (CCC). Technical documentation for the digital vehicle key is published under the name “Digital Key Release”.

The motor vehicle, in particular a safety function of the motor vehicle, can preferably be controlled by means of digital vehicle keys. A vehicle key can comprise either an owner key or a user key. An owner key is preferably granted all authorization rights in relation to the motor vehicle. In particular, when the owner is a natural person, they can also be the owner of the vehicle in the legal sense. An owner key can preferably be used to validate a user key. A method for depositing a user key comprises the step of validating by means of an owner key, whereby the validation is considered to be a cryptographic operation requiring the owner key. This operation can comprise the creation of a digital signature on the basis of the owner key. According to the nomenclature of the Digital Key Release, an owner is also referred to as an owner and a simple user as a friend.

A user key can be restricted in terms of time or content with regard to the control of functions which can be controlled on the vehicle. For example, a user key can only be valid during a predetermined time period or only be authorized for opening the vehicle, but not to drive the vehicle under its own power. According to some versions of the digital key release, it is possible to validate another user key by means of a user key. Authorization for validation can be granted to the user key by an owner.

For a digital vehicle key to be valid, it is generally required for it to be initially validated by the locksmith and then deposited on the vehicle. It is therefore suggested that the inspection for whether the newly created owner key has been assigned to an already known user account or not should be executed at the vehicle, by the locksmith or preferably at both locations.

A created owner key can be stored on the motor vehicle, whereby a comparison is to be implemented by the motor vehicle between the user account associated with the created owner key and a user account of an existing owner key which has been stored on the motor vehicle. Information relating to a vehicle key is usually transmitted to the vehicle in the form of an attestation package. When there is no information about an owner's key located on the vehicle, then the vehicle can be denied a function requested using the owner's key. The comparison which is executed by the motor vehicle can therefore take all created owner keys into account with a high degree of certainty. However, a data connection to the vehicle can be temporarily unavailable, for example when the vehicle is located in an underground parking garage. In this case, the attestation package must be transmitted to the vehicle by a different route.

A created owner key can be deposited with a locksmith, whereby a comparison is made by the locksmith between the user account associated with the created owner key and a user account of an existing owner key which has been deposited with the locksmith. In a procedure for creating an owner key, the comparison can be executed by the locksmith before an attestation package is sent to the vehicle. Since each vehicle key must be signed off by the locksmith to be valid, the comparison by the locksmith can be utilized with a high degree of certainty for each owner key created.

The comparison can be implemented on a cryptographic hash from the user account. The cryptographic hash can be created by a body which manages the owner keys for the motor vehicle. In particular, the body can be operated by a manufacturer of the motor vehicle. The user can also be authenticated to this body so that an owner key is therefore created. The hash can ensure that a known user account is recognized with certainty without providing the name of the user account to the key service or the motor vehicle. The user account is related to the user and can concern personal information which is specially protected and whose disclosure is subjected to data protection rules.

The hash is determined by using a cryptographic scatter function (hash function), which thereby generates an output value of a fixed length from a user account name. Every amendment for the input will result in a differentiation in the output, a collision in which two user accounts are mapped to the same hash is practically impossible. The hash can be created by using a known hash function such as SHA-2 or SHA-3. In the context of the Digital Car Key of the Car Connectivity Consortium, the hash is known as AccountInfoHash and can cover subsequent information in addition to the user account, in particular with regard to the created owner key or the user who has been assigned to it. In one embodiment, a shortened form of the hash is transmitted to the vehicle, which is still collision-free among all vehicle keys for the vehicle.

According to a further aspect of the present invention, there is a control device for a motor vehicle, whereby the control device is adapted to secure the motor vehicle by means of a digital vehicle key. The control device comprises a wireless interface for receiving an attestation packet relating to a digital owner key for the motor vehicle, the attestation packet comprising an indication of a user account of a user to which the digital owner key is associated and the means for processing this. The processing means is adapted to determine that the user account, which is associated with the owner key of a received attestation packet, thereby corresponds to a user account of an already existing owner key stored on the motor vehicle, and only in this case to store the owner key of the attestation packet as an additional owner key on the motor vehicle.

An existing key can only be deleted when it has been determined that the new owner key has been assigned to a user account which is different from user accounts of all known owner keys.

According to yet another aspect of the present invention, a motor vehicle comprises a device described herein. The motor vehicle can comprise a motorcycle or a passenger vehicle and, in additional embodiments, the motor vehicle can also comprise, for example, a truck or a bus.

According to yet another aspect of the present invention, there is a key service for digital vehicle keys for a motor vehicle, whereby the key service comprises an interface for receiving a request to sign a newly created digital owner key for the motor vehicle, the request comprising an indication of a user account of a user to which the digital owner key has been associated and processing means. The processing device is adapted to determine that the user account associated with the request corresponds to a user account of an already existing owner key, which has been stored at the key service, as well as to sign off the created owner key as an additional owner key and store it locally.

An existing key can only be deleted in this case when it has been determined that the new owner key has been assigned to a user account which is different from the user accounts of all known owner keys.

A system comprises a motor vehicle described herein and at least one motor vehicle described herein.

A method described herein can be executed by means of a device described herein and/or a key service described herein. Parts of the method can be implemented on different devices. For this purpose, the control device or the key service can comprise a processing device, which is preferably electronic and comprises, for example, an integrated circuit, a programmable logic module or a programmable microcomputer. The method can be implemented in the form of a configuration or as a computer program product with a program code method for the processing device. The configuration or computer program product can be stored on a non-transitory computer-readable data carrier. Features or advantages of the method can be transferred to the device or vice versa.

The invention will now be described in more detail with reference to the accompanying drawings, in which:

### BRIEF DESCRIPTION OF THE DRAWINGS

FIG. 1 illustrates a system with a motor vehicle,

FIG. 2 illustrates a flow chart of a process, and

FIG. 3 illustrates vehicle keys for a motor vehicle.

### DETAILED DESCRIPTION OF THE DRAWINGS

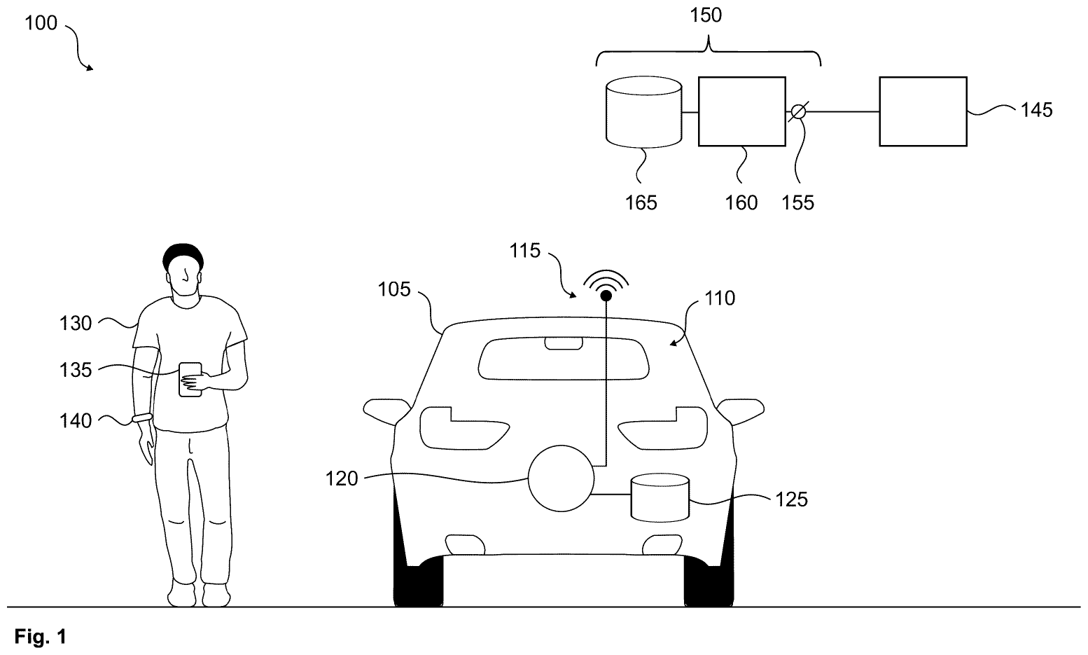

FIG. 1 illustrates a system 100 with a motor vehicle 105 which can be controlled by using the concept of a digital vehicle key in accordance with the specifications of the Car Connectivity Consortium. It is preferred that a chain-like creation of vehicle keys (“key sharing in a chain”, SiaC) is hereby supported.

The motor vehicle 105 comprises a control device 110 with a wireless interface 115 and a processing device 120. Preferably, a secure memory 125 is additionally provided in which digital vehicle keys or other information to be protected can be stored. The control device 110 is adapted to control a predetermined security function of the motor vehicle 105 in dependence on a vehicle key which has been presented on the motor vehicle 105. The security function can relate to a central locking system and/or an immobilizer.

A digital vehicle key in the sense of a vehicle access authorization is a cryptographic design which can be stored as a data structure on a device. A distinction is made between two different types of digital vehicle keys, digital owner keys and digital user keys. A digital owner key is usually assigned to a legal owner of the vehicle and generally has unrestricted rights with regard to the concept of the digital vehicle key. For example, the owner key can generally be utilized to validate or sign a digital user key.

A digital user key is associated with a user who is typically not a legal owner of the motor vehicle 105 and typically possesses limited rights. For example, the user key can only be utilized to control the motor vehicle 105 at certain times or within a predetermined geographic area. A user key cannot usually be utilized to validate or sign another user key.

FIG. 1 illustrates a person 130 who is assigned an owner key for the motor vehicle 105, whereby the owner key is stored on a first mobile device 135 which is assigned to the person 125. The first mobile device 135 is exemplarily designed as a smartphone and comprises a secure memory (trusted platform module, TPM) in which the owner key can be stored. Access to the secure memory can be controlled by means of an operating system of the mobile device 130. To access the secure memory, the person 120 can be required to authenticate themselves to the mobile device 135. For this purpose, the person 130 can, for example, present a predetermined biometric feature or enter a predetermined secret code on the first mobile device 135.

A second mobile device 140 is exemplarily designed as a smart watch, but the actual device type is hereby irrelevant. The second mobile device 140 does not have a digital vehicle key assigned for the motor vehicle 105 yet. The second mobile device 140 is also assigned to the person 130 and the person 130 can therefore be logged into a user account with the same designation on both mobile devices 135 and 140. Such a designation can be specified, for example, in the form of an email address.

For a digital owner key for the motor vehicle 105 to be stored on the second mobile device 140, the person 130 must thereby authenticate themself. This can be completed with an authority 145, for example by presenting documents which prove the identity of the person and/or their ownership of the motor vehicle 105. when the authentication is successful, then an owner key can be created and validated or signed off by a key service 150.

The key service 150 comprises an interface 155 and a processing device 160, a data memory 165 can also be provided. The key service 150 is assigned the task of reviewing requests to validate a created digital vehicle key, validating or signing off the vehicle key and storing validated vehicle keys in the data store 165. Information about a validated vehicle key can then be transmitted to the motor vehicle 105, as explained in more detail below.

In a first case, the person 130 can request a digital owner key for the second mobile device 140, whereby their owner key is to remain on the first mobile device 135. This case can occur, for example, when the person 130 acquires an additional new mobile device 140, which they also wish to utilize in order to control the motor vehicle 105.

In a second case, the power of authority for the motor vehicle 105 is to be transferred from a first person 130 to a second person 130. For this purpose, a new owner key is to be created which overwrites the existing one.

It is hereby proposed to distinguish the two cases based on a user account under which the person 130 is logged on to the mobile device 135, 140 in every case when the owner key is created or requested. When an owner key is to be created to which a user account is assigned that is already assigned to an existing owner key, then it can be determined that the first case is present. The newly created owner key can then be created without affecting an existing owner key—or an existing user key.

However, when the user account for which an owner key is to be created is not yet known from any existing owner key, then it can be determined that the second case therefore applies. The existing owner key can then be deleted and effectively replaced by a new owner key.

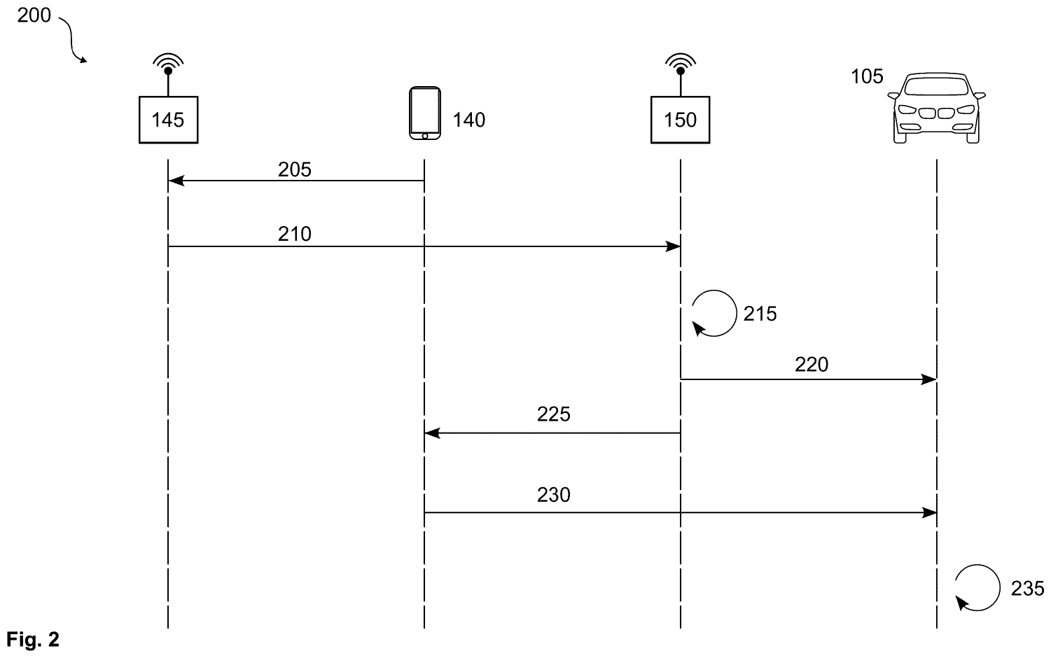

FIG. 2 illustrates a flow chart for an exemplary method for creating a digital owner key for the motor vehicle 105. Participants in the system 100 of FIG. 1 are symbolically shown in an upper area. It is assumed that at least one owner key already exists, which is therefore assigned to a person 130. A new owner key is now to be issued for a person 130.

In Step 205, the person 130 can be authenticated, preferably to the entity 145. The authentication can also be performed to the motor vehicle 105, preferably with the motor vehicle 105 being in communication with the entity 145 and/or the key service 150. The owner key is to be created for a mobile device 140 which is assigned to the person 130. The authentication or a request to create an owner key comprises a reference to a user account under which the person 130 is logged on to the mobile device 135.

In Step 210, the entity 145 hereby determines a hash spanning information relating to the individual 130, whereby the information comprises a reference to the user account. A hash function for creating the hash is designed in such a way that information comprising references to two different user accounts results in different hash values, regardless of what other information is included. Such a property of a hash function is known as strong collision resistance. Such a hash is known as AccountInfoHash in the Digital Car Key according to the proposals of the Car Connectivity Consortium and, for its definition, please refer to the documentation in the Digital Key Release. The specified hash is subsequently forwarded to the key service 150 together with a request to validate the owner key which has been created.

The key service 150 can be utilized to review whether an owner key has already been created for the vehicle 105 to which the same user account has been assigned. For this purpose, the hash can be compared with corresponding hashes which are assigned to the stored digital vehicle keys. when a hash of a stored owner key is located which therefore corresponds to the hash of the newly created owner key, then the person 130 of the newly created owner key must be logged into the same user account as the person 130 of the existing owner key. It can therefore be determined that person 130 wishes to create an additional owner key. In this case, the new owner key can be validated and saved without amending or deleting other vehicle keys.

If, on the other hand, the hash of the newly created owner key is deemed to be new when compared to all hashes of owner keys which already exist for the motor vehicle 105, then the person 130 of the new owner key uses a user account which is still unknown and it can be assumed that it is a person 130 which is not yet known. In this case, the new owner key can be validated and saved, and the old owner key can be subsequently deleted. In addition, user keys which have been stored on the key service 150 and which are validated using the existing old key can be deleted.

An attestation package containing information about the newly created owner key can be transmitted from the key service 150 to the motor vehicle 105 in Step 220. The transmission is to be preferably implemented as wireless, in particular by means of mobile radio. The information comprises a public part of a cryptographic key, the associated private part of which is stored on the mobile device 135, 140 of the person 130. In addition, the information comprises a reference to the user account utilized, preferably in the form of the hash created by the location 145.

If the attestation package cannot be delivered directly to the motor vehicle 105, for example, because a wireless data connection to the motor vehicle is not available, then the attestation package can be transmitted to a mobile device 130, 140 of the person 130 in Step 225. For the person 130 to be able to utilize the owner key on the motor vehicle 105, the person 130 must approach the mobile device 135, 140 so that a wireless data connection is therefore possible, for example, via Bluetooth (BT) or Bluetooth Low Energy (BLE).

The attestation package can be transmitted via this data connection in Step 230 before mutual authentication is implemented between the mobile device 135, 140 and the control device 110 of the motor vehicle 105. The authentication is to be based on a challenge-response authentication based on a public and a private cryptographic key of one of the participants. Furthermore, and preferably, both participants are to be authenticated against each other in a transaction (refer to Digital Key Release: “standard transaction”).

In Step 235, the motor vehicle 105 or the control device 110 can review whether a user account, which is associated with the received owner key, is known from an owner key which has been previously created and stored in the motor vehicle 105. For this purpose, a comparison can again be implemented based on hash values which have been calculated via the respective user accounts. The procedure can correspond to that of Step 215.

If it is determined that the new owner key is associated with a user account which is associated with an owner key which has already been stored in the motor vehicle 105, then the new owner key can be stored by the motor vehicle 105 without amending or deleting any other vehicle key already stored therein.

Otherwise, the old owner key can be deleted and the new owner key stored. In this case, user keys which have been stored by the vehicle, and which are signed off with the old owner key found can also be deleted.

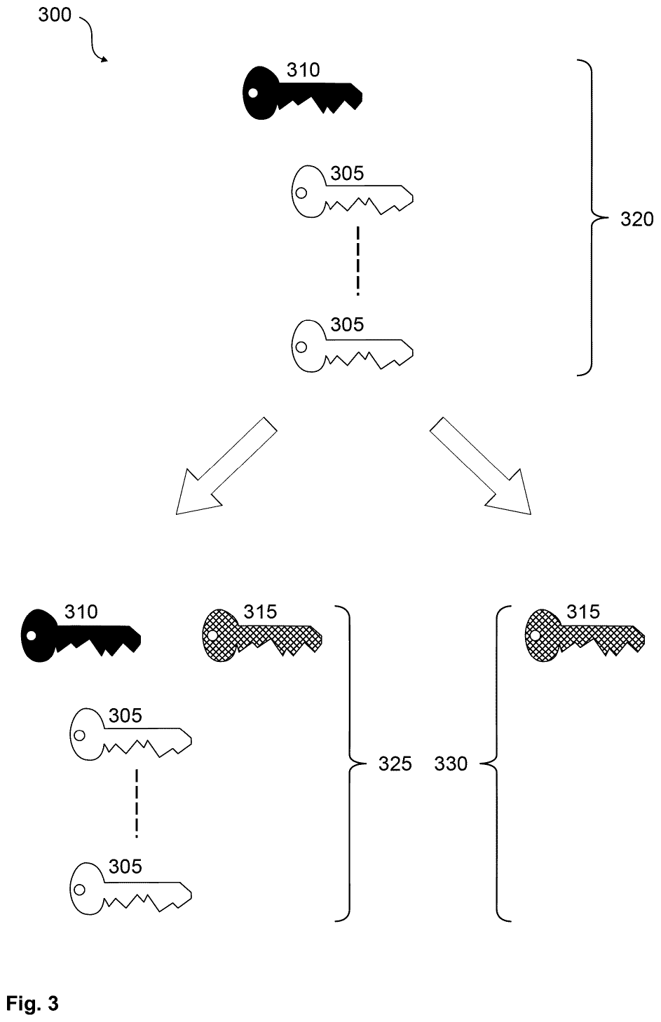

FIG. 3 illustrates a representation 200 for vehicle keys of a motor vehicle 105. User keys 305 are illustrated in light shading, an already stored owner key 310 is illustrated in dark shading and a new owner key 315 to be stored is shown with a pattern. The representation can relate to vehicle keys which have been stored by the key service 150 or by the motor vehicle 105 or the control device 110.

A first set of vehicle keys 320 is illustrated in an upper area, which is hereby assumed. Before the new owner key 315 is added, a review must be executed to see whether the new owner key 315 has been assigned to a user account which is assigned to the old owner key 310.

If this is the case, then the result is a second set 325 of vehicle keys as represented in a lower left area of FIG. 3. The new owner key 315 is simply added to the vehicle keys 305 and 310 which have been already stored.

If the user account of the new owner key 315 does not correspond to any user account of an old owner key 310, then this will result in a third set 330 of vehicle keys as represented in a lower right area of FIG. 3. The new owner key 315 thereby replaces the old owner key 310 and user keys 305, which were validated with the old owner key 310, will be deleted.

If user keys exist which are validated with an owner key other than the old owner key 310 exist, then these can also be deleted. If there is another known owner key 310, then this can also be deleted.

Reference Indications

| | |
|---|---|
| 100 | System |
| 105 | Motor vehicle |
| 110 | Control device |
| 115 | Wireless interface |
| 120 | Processing equipment |
| 125 | Secure storage |
| 130 | Person |
| 135 | First mobile device |
| 140 | Second mobile device |
| 145 | Position |
| 150 | Locksmith service |
| 155 | Interface |
| 160 | Processing equipment |
| 165 | Data memory |
| 205 | Authenticate person |
| 210 | Provide reference to user account |
| 215 | Signing off and storing owner keys |
| 220 | Transfer attestation package to motor vehicle |
| 225 | Transfer attestation package to mobile device |
| 230 | Transfer attestation package to motor vehicle |
| 235 | Store owner key |
| 300 | Illustration |
| 305 | User key |
| 310 | Old owner key |
| 315 | New owner key |
| 320 | First set |
| 325 | Second set |
| 330 | Third set |

What is claimed is:

1. A method for controlling a motor vehicle, the method comprising:
authenticating a user of a mobile device, including determining a user account of the user;
determining that the user account corresponds to a user account associated with an existing owner key for the motor vehicle; and
storing an additional digital owner key of the vehicle for the user.

2. The method according to claim 1, wherein the existing owner key is to be deleted when it is determined that the user account of the additional digital owner key is different from all user accounts associated with one of a plurality of existing owner keys.

3. The method according to claim 2, wherein all the existing owner keys are deleted.

4. The method according to claim 1, wherein a digital vehicle key which has been validated with the existing owner key is deleted.

5. The method according to claim 2, wherein a digital vehicle key which has been validated with the existing owner key is deleted.

6. The method according to claim 1, wherein the user is logged on to the mobile device under the user account.

7. The method according to claim 2, wherein the user is logged on to the mobile device under the user account.

8. The method according to claim 1, wherein the digital vehicle key is implemented according to specifications of Car Connectivity Consortium.

9. The method according to claim 1, wherein the motor vehicle is controllable by digital vehicle keys, wherein each of the digital vehicle keys is either an owner key or a user key and the owner key is granted all authorization rights with respect to the motor vehicle.

10. The method according to claim 2, wherein the motor vehicle is controllable by digital vehicle keys, wherein each of the digital vehicle keys is either an owner key or a user key and the owner key is granted all authorization rights with respect to the motor vehicle.

11. The method according to claim 1, wherein a created owner key is to be stored on the motor vehicle and a comparison is implemented by the motor vehicle between the user account associated with the created owner key and a user account of an already existing owner key which has been stored on the motor vehicle.

12. The method according to claim 2, wherein a created owner key is to be stored on the motor vehicle and a comparison is implemented by the motor vehicle between the user account associated with the created owner key and a user account of an already existing owner key which has been stored on the motor vehicle.

13. The method according to claim 1, wherein a created owner key is deposited with a locksmith and a comparison is implemented by the locksmith between the user account associated with the created owner key and a user account of an already existing owner key deposited with the locksmith.

14. The method according to claim 2, wherein a created owner key is deposited with a locksmith and a comparison is implemented by the locksmith between the user account associated with the created owner key and a user account of an already existing owner key deposited with the locksmith.

15. The method according to claim 11, wherein the comparison is implemented on a cryptographic hash of the user account.

16. The method according to claim 13, wherein the comparison is implemented on a cryptographic hash of the user account.

17. A control device for a motor vehicle, wherein the control device is arranged to secure the motor vehicle by a digital vehicle key, the control device comprising:
a wireless interface for receiving an attestation package relating to a digital owner key for the motor vehicle, wherein the attestation package includes an indication of a user account of a user to which the digital owner key is associated; and
a processing device configured to determine that the user account associated with the owner key of a received attestation package is a user account of an existing owner key which has been stored on the motor vehicle, and to store the owner key of the attestation package as an additional owner key on the motor vehicle.

18. A motor vehicle comprising a control device according to claim 17.

19. A key service for digital vehicle keys for a motor vehicle, the key service comprising:
an interface for receiving a request to sign a newly created digital owner key for the motor vehicle, wherein the request includes a reference to a user account of a user to which the digital owner key is associated; and
a processing device configured to determine that the user account which is associated with the request corresponds to a user account of an existing owner key that has been stored at the key service, and to sign off the created owner key as an additional owner key and store the created owner key locally.

20. A system comprising:
a locksmith; and
a motor vehicle according to claim 18.
